(19) United States
(12) Patent Application Publication
(10) Pub. No.: US 2014/0274193 A1
(43) Pub. Date: Sep. 18, 2014

(54) OUT-OF-BAND NOISE AND OVERLOAD PROTECTION

(71) Applicant: Wilson Electronics, LLC, St. George, UT (US)

(72) Inventors: Christopher K. Ashworth, St. George, UT (US); Vernon A. Van Buren, Cedar City, UT (US); Patrick L. Cook, St. George, UT (US); Richard M. Kline, Cedar City, UT (US)

(73) Assignee: WILSON ELECTRONICS, LLC, St. George, UT (US)

(21) Appl. No.: 13/837,026

(22) Filed: Mar. 15, 2013

(51) Int. Cl. H04W 52/24

(52) U.S. Cl. CPC H04W 52/243
USPC 455/522

(57) ABSTRACT

A method for providing overload or noise protection may include applying an amplification factor to a first-band signal transmitted in a first frequency band. The first frequency band may include a first uplink band and a first downlink band. The amplification factor may be applied by an amplification circuit configured for signals transmitted in the first frequency band. The method may further include detecting a second-band signal transmitted in a second frequency band. The second frequency band may include a second uplink band and a second downlink band. Additionally, the method may include adjusting the amplification factor based on the detected second-band signal.

### FIELD

The present disclosure relates to noise and overload protection for out-of-band frequency bands.

### BACKGROUND

Signal boosters may be used to improve communication between a wireless device and a wireless communication access point. Signal boosters may improve the communication between the wireless device and the wireless communication access point by amplifying, filtering, and/or applying other processing techniques to signals communicated between the wireless device and the wireless communication access point. However, signal boosters may also decrease the quality of other wireless communications by interfering with the other wireless communications.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a method for providing overload or noise protection may include applying an amplification factor to a first-band signal transmitted in a first frequency band. The first frequency band may include a first uplink band and a first downlink band. The amplification factor may be applied by an amplification circuit configured for signals transmitted in the first frequency band. The method may further include detecting a second-band signal transmitted in a second frequency band. The second frequency band may include a second uplink band and a second downlink band. Additionally, the method may include adjusting the amplification factor based on the detected second-band signal.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates an example wireless communication system;

FIG. 2 illustrates an example embodiment of a signal booster configured to provide overload and/or noise protection;

FIG. 3 illustrates another example embodiment of a signal booster configured to provide overload and/or noise protection; and

FIG. 4 is a flow chart of an example method of providing overload and/or noise protection.

### DESCRIPTION OF EMBODIMENTS

According to some embodiments, a transmitting device (e.g., a signal booster) may include an amplification circuit configured to apply an amplification factor to a first-band signal that may be transmitted in a first frequency band. The amplification circuit may be configured and designed for signals that may be transmitted in the first frequency band. Accordingly, the first frequency band may also be referred to as an “in-band” frequency band with respect to the amplification circuit. Additionally, as detailed below, the transmitting device may be configured to adjust the amplification factor for the in-band frequency band based on a second-band signal that may be transmitted in a second frequency band such that interference in the second frequency band that may be caused by the transmitting device may be reduced. The amplification circuit may not be configured or designed for the second frequency band such that the second frequency band may be referred to as an “out-of-band” frequency band.

The transmitting device may be configured to adjust the amplification factor of the amplification circuit based on the detected second-band signal even though the second frequency band may be an out-of-band frequency band. In contrast, other transmitting devices (e.g., signal boosters) may adjust their amplification factors solely based on the frequencies within their respective bands of interest. In some embodiments, the transmitting device may be configured to adjust an uplink amplification factor that may be applied to a first-band uplink signal based on a detected second-band downlink signal.

The term “uplink” may refer to communications that are transmitted to a wireless communication network access point from the wireless device. The term “downlink” may refer to communications that are transmitted to the wireless device from the wireless communication network access point.

Additionally, wireless communication may be used in a wide variety of applications and for a variety of uses. Because of the many uses, portions of a frequency spectrum (commonly referred to as “bands”) used for wireless communication may be designated for certain uses to help reduce interference experienced by many uses of the wireless communication. Additionally, as alluded to above, the terms “frequency range,” “frequency band,” “communication band,” or “band” may refer to one or more applicable frequencies within the electromagnetic spectrum that may be used to perform wireless communication. In some embodiments, the terms “frequency range,” “frequency band,” “communication band,” or “band” may also refer to frequencies designated for a particular use (e.g., cellular communication, public safety communication, uplink communication, downlink communication, etc.). Further, in some instances a “frequency range,” “frequency band,” “communication band,” or “band” may refer to a contiguous frequency range while in other instances the terms “frequency range,” “frequency band,” “communication band,” or “band” may refer to multiple non-contiguous frequency ranges. Additionally, as indicated above, a “frequency range,” “frequency band,” “communication band” or “band” may include one or more sub-ranges or sub-bands (e.g., a frequency band may include an uplink band and a downlink band).

In some instances, the frequency ranges associated with designated bands may be separated by a certain degree of frequency spacing referred to as a guard band. The guard band may help reduce interference between signals transmitted within different designated bands. As described in detail below, in some instances, the guard bands may be substantially narrow such that distinguishing between and therefore processing signals that may be transmitted in bands separated by a narrow guard band may be difficult.

FIG. 1 illustrates an example wireless communication system 100 (referred to hereinafter as “system 100”), arranged in accordance with at least some embodiments described herein. The system 100 may be configured to provide wireless communication services to a wireless device 106 via an access point 104. The system 100 may further include a signal booster 102. The signal booster 102 may be any suitable system, device, or apparatus configured to receive signals communicated between the access point 104 and the wireless device 106. The signal booster 102 may be configured to amplify, repeat, filter, or otherwise process the received signals and may be configured to re-transmit the processed signals. Although not expressly illustrated in FIG. 1, the system 100 may include any number of access points 104 providing wireless communication services to any number of wireless devices 106.

The wireless communication services provided by the system 100 may include voice services, data services, messaging services, and/or any suitable combination thereof. The system 100 may include a Frequency Division Duplexing network, a Frequency Division Multiple Access (FDMA) network, an Orthogonal FDMA (OFDMA) network, a Code Division Multiple Access (CDMA) network, a Time Division Multiple Access (TDMA) network, a Direct Sequence Spread Spectrum (DSSS) network, a Frequency Hopping Spread Spectrum (FHSS) network, a wireless (Wi-Fi) local network, such as an 802.11 network, and/or some other wireless communication network. In some embodiments, the system 100 may be configured to operate as a second generation (2G) wireless communication network, a third generation (3G) wireless communication network, a fourth generation (4G) wireless communication network, and/or a Wi-Fi network. In these or other embodiments, the system 100 may be configured to operate as a Long Term Evolution (LTE) wireless communication network.

The access point 104 may be any suitable wireless network communication access point and may include, by way of example but not limitation, a base station, a remote radio head (RRH), a satellite, a wireless router, or any other suitable communication access point. The wireless device 106 may be any device that may use the system 100 for obtaining wireless communication services and may include, by way of example and not limitation, a cellular phone, a smartphone, a personal data assistant (PDA), a laptop computer, a personal computer, a tablet computer, a wireless communication card, or any other similar device configured to communicate within the system 100.

As signals propagate between the access point 104 and the wireless device 106, the signals may be affected during the propagation such that, in some instances, the wireless signals communicated between the access point 104 and the wireless device 106 may be substantially degraded. The signal degradation may result in the access point 104 or the wireless device 106 not receiving, detecting, or extracting information from the wireless signals. Therefore, the signal booster 102 may be configured to increase the power of and/or improve the signal quality of the wireless signals such that the communication of the wireless signals between the access point 104 and the wireless device 106 may be improved.

In some embodiments, the signal booster 102 may receive a wireless signal communicated between the access point 104 and the wireless device 106 that may be converted into an electrical signal (e.g., via an antenna). The signal booster may be configured to amplify the electrical signal and the amplified electrical signal may be converted into an amplified wireless signal that is transmitted. The signal booster 102 may amplify the electrical signal by applying a gain to the electrical signal. The gain may be a set gain or a variable gain, and may be less than, equal to, or greater than one. Therefore, in the present disclosure, the term “amplify” may refer to applying any gain to a wireless signal even if the gain is less than one.

In some embodiments, the signal booster 102 may adjust the gain based on conditions associated with communicating the wireless signals (e.g., providing noise floor, oscillation, and/or overload protection). In these and other embodiments, the signal booster 102 may adjust the gain in real time. The signal booster 102 may also filter out noise associated with the received wireless signal such that the retransmitted wireless signal may be a cleaner signal than the received wireless signal. Therefore, the signal booster 102 may improve the communication of wireless signals between the access point 104 and the wireless device 106.

For example, the wireless device 106 may communicate a wireless uplink signal 112 intended for reception by the access point 104 and a first antenna 108 may be configured to receive the wireless uplink signal. The first antenna 108 may be configured to convert the received wireless uplink signal 112 into an electrical uplink signal. Additionally, the first antenna 108 may be communicatively coupled to a first interface port (not expressly depicted in FIG. 1) of the signal booster 102 such that the signal booster 102 may receive the electrical uplink signal 112 at the first interface port. An interface port may be any suitable port configured to interface the signal booster 102 with another device (e.g., an antenna or a modem) from which the signal booster 102 may receive a signal and/or to which the signal booster 102 may communicate a signal.

In some embodiments, the signal booster 102 may be configured to apply a gain to the electrical uplink signal to amplify the electrical uplink signal. In the illustrated embodiment, the signal booster 102 may direct the amplified electrical uplink signal toward a second interface port (not expressly depicted in FIG. 1) of the signal booster 102 that may be communicatively coupled to a second antenna 110. The second antenna 110 may be configured to receive the amplified electrical uplink signal from the second interface port and may convert the amplified electrical uplink signal into an amplified wireless uplink signal 114 that may also be transmitted by the second antenna 110. The amplified wireless uplink signal 114 may be received by the access point 104.

In some embodiments, the signal booster 102 may also be configured to filter the electrical uplink signal to remove at least some noise associated with the received wireless uplink signal 112. Consequently, the amplified wireless uplink signal 114 may have a better signal to noise ratio (SNR) than the wireless uplink signal 112 that may be received by the first antenna 108. Accordingly, the signal booster 102 may be configured to improve the communication of uplink signals between the access point 104 and the wireless device 106. The use of the term “uplink signal” without specifying wireless or electrical uplink signals may refer to wireless uplink signals or electrical uplink signals.

As another example, the access point 104 may communicate a wireless downlink signal 116 intended for the wireless device 106 and the second antenna 110 may be configured to receive the wireless downlink signal 116. The second antenna 110 may convert the received wireless downlink signal 116 into an electrical downlink signal such that the electrical downlink signal may be received at the second interface port of the signal booster 102. In some embodiments, the signal booster 102 may be configured to apply a gain to the electrical downlink signal to amplify the electrical downlink signal. The signal booster 102 may also be configured to direct the amplified electrical downlink signal toward the first interface port of the signal booster 102 such that the first antenna 108 may receive the amplified electrical downlink signal. The first antenna 108 may be configured to convert the amplified electrical downlink signal into an amplified wireless downlink signal that may also be transmitted by the first antenna 108. Accordingly, the amplified downlink signal 118 may be received by the wireless device 106.

In some embodiments, the signal booster 102 may also be configured to filter the electrical downlink signal to remove at least some noise associated with the received wireless downlink signal 116. Therefore, the amplified wireless downlink signal 118 may have a better SNR than the wireless downlink signal 116 received by the second antenna 110. Accordingly, the signal booster 102 may also be configured to improve the communication of downlink signals between the access point 104 and the wireless device 106. The use of the term “downlink signal” without specifying wireless or electrical downlink signals may refer to wireless downlink signals or electrical downlink signals.

Modifications may be made to the system 100 without departing from the scope of the present disclosure. For example, in some embodiments, the distance between the signal booster 102 and the wireless device 106 may be relatively close as compared to the distance between the signal booster 102 and the access point 104. Further, the system 100 may include any number of signal boosters 102, access points 104, and/or wireless devices 106. Additionally, in some embodiments the signal booster 102 may be integrated with the wireless device 106, and in other embodiments, the signal booster 102 may be separate from the wireless device 106. Also, in some embodiments, the signal booster 102 may be included in a cradle configured to hold the wireless device 106. Additionally, in some embodiments, the signal booster 102 may be configured to communicate with the wireless device 106 via wired communications (e.g., using electrical signals communicated over a wire) instead of wireless communications (e.g., via wireless signals).

Further, in some embodiments, as mentioned above, the signal booster 102 may be configured such that the signal booster 102 may adjust the amplification provided by the signal booster 102 such that interference within one or more frequency bands that may be outside of the frequency band associated with communication between the access point 104 and the wireless device 106 may be reduced.

Additionally, although the signal booster 102 is illustrated and described with respect to receiving and transmitting signals via the first antenna 108 and the second antenna 110, the scope of the present disclosure is not limited to such applications. For example, in some embodiments, the signal booster 102 (or other signal boosters described herein) may receive and/or transmit signals via one or more modems.

FIG. 2 illustrates an example embodiment of a signal booster 202 configured to provide out-of-band overload and/or noise protection, arranged in accordance with at least some embodiments described herein. In some embodiments, the signal booster 202 may be configured to operate in a manner analogous to the signal booster 102 of the system 100 of FIG. 1. The signal booster 202 may include a first interface port 209 communicatively coupled to a first antenna 208 and a second interface port 211 communicatively coupled to a second antenna 210. The signal booster 202 may also include an uplink path 204 and a downlink path 206, communicatively coupled between the first interface port 209 and the second interface port 211.

The uplink path 204 may include an uplink gain unit 214 and the downlink path 206 may include a downlink gain unit 215. The uplink gain unit 214 and the downlink gain unit 215 may include one or more amplifiers, attenuators or any other suitable component configured to apply a gain to signals received by the uplink gain unit 214 or received by the downlink gain unit 215. The gain may be a set gain or a variable gain and may be less than, equal to, or greater than one. In some embodiments, the gain of the uplink gain unit 214 and the downlink gain unit 215 may be adjusted together or independently by a control unit 223 communicatively coupled to the uplink gain unit 214 and the downlink gain unit 215. In some embodiments, the control unit 223 may adjust the gain of the uplink gain unit 214 and the downlink gain unit 215 based on wireless communication conditions.

The control unit 223 may be implemented by any suitable mechanism, such as a program, software, function, library, software as a service, analog or digital circuitry, or any combination thereof. The control unit 223 may also include a processor coupled to memory. The processor may include, for example, a microprocessor, microcontroller, digital signal processor (DSP), application specific integrated circuit (ASIC), a Field Programmable Gate Array (FPGA), or any other digital or analog circuitry configured to interpret and/or to execute program instructions and/or to process data. In some embodiments, the processor may interpret and/or execute program instructions and/or process data stored in the memory. The instructions may include instructions for adjusting the gain of the gain units 214 and 215. For example, the adjustments may be based on radio frequency (RF) signal inputs.

The memory may include any suitable computer readable media configured to retain program instructions and/or data for a period of time. By way of example, and not limitation, such computer readable media may include tangible computer readable storage media including random access memory (RAM), read only memory (ROM), read only memory (ROM), electrically erasable programmable read only memory (EEPROM), compact disk read only memory (CD ROM) or other optical disk storage, magnetic disk storage or other magnetic storage devices, flash memory devices (e.g., solid state memory devices), or any other storage medium which may be used to carry or store desired program code in the form of computer executable instructions or data structures and which may be accessed by a general purpose or special purpose computer. Combinations of the above may also be included within the scope of computer readable media. Computer executable instructions may include, for example, instructions and data that cause a general purpose computer, special purpose computer, or special purpose processing device to perform a certain function or group of functions.

The signal booster 202 may be configured such that uplink signals that may be received at the first interface port 209 from the first antenna 208 may be directed toward the uplink path 204. The signal booster 202 may also be configured such that the uplink signals may be directed from the uplink path 204 toward the second interface port 211 and the second antenna 210. Additionally, the signal booster 202 may be configured such that downlink signals that may be received at the second interface port 211 from the second antenna 210 may be directed toward the downlink path 206. The signal booster 202 may also be configured to direct the downlink signals from the downlink path 206 toward the first interface port 209 and the first antenna 208.

The signal booster 202 may also include duplexers 212a and 212b. The duplexer 212a may be any suitable system, apparatus, or device configured to direct uplink signals that may be received at the first interface port 209 toward the uplink amplification path 204. The duplexer 212a may also be configured to receive downlink signals that may exit the downlink amplification path 206 and may be configured to direct the downlink signals toward the first interface port 209 and the first antenna 208.

The duplexer 212b may be any suitable system, apparatus, or device configured to direct downlink signals that may be received at the second interface port 211 toward the downlink amplification path 206. The duplexer 212b may also be configured to receive uplink signals that may exit the uplink amplification path 204 and may be configured to direct the uplink signals toward the second interface port 211 and the second antenna 210.

In some embodiments, the signal booster 202 may include an amplification circuit (e.g., the uplink path 204 and the downlink path 206) that may be configured for signals that may be communicated in a first-frequency band (referred to as “first-band signals”) such that the first-frequency band may be an in-band frequency band with respect to the uplink path 204 and the downlink path 206. In some embodiments, the first-band signals may be first-band uplink signals that may transmitted in a first uplink band of the first frequency band or the first-band signals may be first-band downlink signals that may transmitted in a first downlink band of the first frequency band.

In some embodiments, the duplexers 212a and 212b may each include a first-band uplink filter and a first-band downlink filter. The first-band uplink filters may be configured based on the first uplink band such that frequencies within the first uplink band may pass through the first-band uplink filters while frequencies outside of the first uplink band may be filtered out by the first-band uplink filters. For example, the first-band uplink filters may be configured to allow the first-band uplink signals to pass through the first-band uplink filters and may be configured to filter out first-band downlink signals.

The first-band downlink filters may be similarly configured based on the first downlink band of the first frequency band such that frequencies within the first downlink band may pass through the first-band downlink filters while frequencies outside of the first downlink band may be filtered out by the first-band downlink filters. For example, the first-band downlink filters may be configured to allow the first-band downlink signals to pass through the first-band downlink filters and may be configured to filter out first-band uplink signals.

In some embodiments, a guard band between the first frequency band and a second frequency band that may be an out-of-band frequency band may be relatively narrow (e.g., less than 30 megahertz (MHz)). For example, in some embodiments, a first guard band between the first uplink band and a second uplink band of the second frequency band, a second guard band between the first uplink band and a second downlink band of the second frequency band, a third guard band between the first downlink band and the second uplink band, and/or a fourth guard band between the first downlink band and the second downlink band may be relatively narrow.

Additionally, in some embodiments, the first-band uplink filters and/or the first-band downlink filters of the duplexers 212a and 212b may have a roll off such that at least a portion of signals (uplink and/or downlink) that may be communicated in the second frequency band (referred to as “second-band signals”) and/or noise within the second frequency band (referred to as “second-band noise”) may enter the uplink path 204 and/or the downlink path 206. As such, in some embodiments, the uplink path 204 and/or the downlink path 206 may unintentionally amplify the second-band signals and the second-band noise even though the uplink path 204 and the downlink path 204 may be configured and designed for first-band signals and not second-band signals.

If left unchecked, the amplification of the second-band signals and/or second-band noise may increase a noise floor associated with the second frequency band such that communication in the second frequency band may be disrupted. Additionally, in some instances, an amplified second-band signal may be substantially stronger than unamplified second-band signals such that the unamplified second-band signals may be disrupted or overloaded by the amplified second-band signal.

Accordingly, in some embodiments, the signal booster 202 may be configured to detect the second-band signals and may perform operations based on the second-band signals such that disruption of second-band communications by the signal booster 202 may be reduced or eliminated. For example, in some embodiments, the signal booster 202 may be configured to adjust one or more amplification factors associated with the uplink path 204 and/or the downlink path 206 based on the detected second-band signals such that disruption of second-band communications that may be caused by amplification applied by the uplink path 204 and/or the downlink path 206 to the second-band signals and/or second-band noise may be reduced or eliminated.

In the illustrated embodiment of FIG. 2, the amplification circuit of the signal booster 202 that may include the uplink path 204 and the downlink path 206 may be configured for the first-band where the first uplink band may be separated from the second uplink band and the second downlink band by a substantially narrow guard band. Additionally, a size of the guard bands between the first uplink band and the second uplink and downlink bands and the roll off of the first-band uplink filters of the duplexers 212a and 212b may be such that at least a portion of the second uplink band and the second downlink band may pass through the first-band uplink filters of the duplexers 212a and 212b. Accordingly, in the illustrated embodiment, the uplink path 204 may unintentionally apply an amplification factor to second-band uplink and downlink signals as well as increase the noise floor of the second frequency band. Therefore, in some embodiments, the signal booster 202 may be configured to adjust an uplink amplification factor applied by the uplink path 204 such that disruption of second-band communications by the signal booster 202 may be reduced or eliminated.

For example, in some embodiments, the amplification circuit of the signal booster 202, which may include the uplink path 204 and the downlink path 206, may be configured for a “Band 13” of a 700 MHz band plan that may be based on frequency allocation by the United States Federal Communications Commission (FCC) and/or the Third Generation Partnership Project (3GPP) standard for wireless communications (referred to hereinafter as “the 700 MHz band plan”). The Band 13 may include a downlink band (referred to hereinafter as the “Band 13 downlink band”) that may include frequencies in the 746-757 MHz range. The Band 13 may also include an uplink band (referred to hereinafter as the “Band 13 uplink band”) that may include frequencies in the 776-787 MHz range. Therefore, in some embodiments, the downlink path 206 may be configured for the Band 13 downlink band (e.g., frequencies in the 746-757 MHz range) and the uplink path 204 may be configured for the Band 13 uplink band (e.g., frequencies in the 776-787 MHz range).

The 700 MHz band plan may also include a public safety band that may include a public safety uplink band and a public safety downlink band. The public safety uplink band may include frequencies between 758 and 775 MHz and the public safety downlink band may include frequencies between 788 and 805 MHz. Therefore, the guard band between the Band 13 uplink band and the public safety uplink band may be one MHz and the guard band between the Band 13 uplink band and the public safety downlink band may also be one MHz.

Additionally, in embodiments where the uplink path 204 is configured for the Band 13 uplink band, the roll off of the first-band uplink filters of the duplexers 212a and 212b may not be steep enough to filter out frequencies separated by one MHz. Therefore, in some embodiments, at least a portion of some public safety uplink and/or downlink signals may pass into the uplink path 204. Therefore, the uplink path 204 may unintentionally amplify the public safety uplink and/or downlink signals. Accordingly, in some embodiments, the signal booster 202 may be configured to adjust an uplink amplification factor applied by the uplink path 204 such that disruption of public safety communications by unintentionally amplifying the public safety uplink and/or downlink signals by the signal booster 202 may be reduced or eliminated.

In the illustrated embodiment, the signal booster 202 may be configured such that disruption of second-band communication by the unintentionally amplified second-band signals (e.g., unintentionally amplified public safety signals) at an access point configured to communicate in the second frequency band (also referred to as a “second-band access point”) may be reduced or eliminated. In some embodiments, the signal booster 202 may include a detecting circuit 230 that may be configured to detect second-band downlink signals that may be communicated by the second-band access point. As disclosed in further detail below, in some embodiments, the control unit 223 may be configured to adjust the uplink amplification factor based on the detected second-band downlink signals such that disruption of second-band communications may be reduced or eliminated.

In the illustrated embodiment, the uplink path 204 may include a directional coupler 216. The directional coupler 216 may be communicatively coupled between the duplexer 212b and the gain unit 214. Additionally, the directional coupler 216 may be communicatively coupled to the detecting circuit 230. The directional coupler 216 may be any suitable system, apparatus, or, device configured to direct signals propagating from the duplexer 212b toward the detecting circuit 230. Additionally, the directional coupler 216 may be configured to direct signals propagating from the gain unit 214 toward the duplexer 212b and away from the detecting circuit 230. Therefore, the directional coupler 216 may be configured to direct signals (e.g., second-band downlink signals) that may be received by the second interface port 211 and that may pass through the first-band uplink filter of the duplexer 212b toward the detecting circuit 230. The directional coupler 216 may also be configured such that signals (e.g., first-band uplink signals) that may leave the gain unit 214 may be substantially directed toward the duplexer 212b and away from the detecting circuit 230.

In some embodiments, to further reduce the incidence of the detecting circuit 230 receiving first-band uplink signals, during detection of second-band downlink signals, the gain of the gain unit 214 may be substantially reduced or set to approximately zero, or the gain unit 214 may be turned off such that first-band uplink signals that may be received by the detecting circuit 230 may be substantially reduced or eliminated. Additionally, in some of these embodiments, the directional coupler 216 may be omitted, or replaced by a pick-up resistor or capacitor, and the gain of the gain unit 214 may be substantially reduced or set to approximately zero, or the gain unit 214 may be turned off during detection of the second-band downlink signals such that first-band uplink signals that may be received by the detecting circuit 230 may be substantially reduced or eliminated

In some embodiments, the detecting circuit 230 may include a second-band downlink BPF 234 communicatively coupled to the directional coupler 216 and configured to receive signals from the directional coupler 216. The second-band downlink BPF 234 may be configured based on the second-band downlink band such that frequencies within the second-band downlink band may pass through the second-band downlink BPF 234 while frequencies outside of the second-band downlink band may be filtered out by the second-band downlink BPF 234. Accordingly, second-band downlink signals may be output by the second-band downlink BPF 234 and other frequencies may be filtered out by the second-band downlink BPF 234.

In some embodiments, the second-band downlink BPF 234 may be communicatively coupled to a gain unit 236 of the detecting circuit 230. The gain unit 236 may be substantially similar to the uplink gain unit 214 and/or the downlink gain unit 215 and may be configured to apply a gain to signals that may be output by the second-band downlink BPF 234 (e.g., second-band downlink signals). The gain unit 236 may be communicatively coupled to a detecting unit 238 that may be configured to receive the second-band downlink signals from the gain unit 236.

The detecting unit 238 may be any suitable system, apparatus, or device configured to detect a signal power of the second-band downlink signals. In some embodiments, the gain unit 236 may be communicatively coupled to the control unit 223 and the control unit 223 may adjust the gain applied by the gain unit 236 such that the detecting unit 238 may detect the power of the second-band downlink signals. In other embodiments, the gain unit 236 and/or the BPF 234 may be omitted from the detecting circuit 230 and the detecting unit 238 may be configured such that the detecting unit 238 may detect the power of the second-band downlink signals without amplification performed by the gain unit 238.

The detecting unit 238 may be communicatively coupled to the control unit 223 such that the control unit 223 may determine the signal power of the second-band downlink signals that may be detected by the detecting unit 238. Based on the determined signal power of the second-band downlink signals, the control unit 223 may be configured to predict interference that may occur in the second frequency band (e.g., interference that may be experienced by the second-band access point) that may be caused by the signal booster 202.

For example, in some embodiments, the control unit 223 may be configured to determine a potential increase in a noise floor and/or overload at the second-band access point based on the received and detected second-band downlink signals and based on a particular transmission power of the second-band downlink signals, as discussed below.

For example, the second-band access point may be configured to transmit the second-band downlink signals at a particular transmission power and the control unit 223 may include information stored therein (e.g., stored in memory of the control unit 223) associated with the particular transmission power of the second-band downlink signals. In some embodiments, the information may include an estimated transmission power or the information may include the actual transmission power as designated by or for a second-band wireless communication network configured to operate in the second frequency band.

Based on the power of the received second-band downlink signals and the particular transmission power of the received second-band downlink signals, the control unit 223 may be configured to estimate a pathloss between the second-band access point and the signal booster 202. In these or other embodiments, the control unit 223 may also be configured to estimate a distance between the signal booster 202 and the second-band access point based on the pathloss. The control unit 223 may be configured to estimate the pathloss and/or distance using any applicable procedure or process.

Based on the pathloss and/or the distance, the control unit 223 may adjust the uplink amplification factor (e.g., decrease the gain, turn off the gain unit 214, etc.) of the uplink path 204 such that interference of second-band communication experienced by the second-band access point that may be caused by the unintentionally amplified second-band uplink signals may be reduced.

For example, the second-band communication network may be configured such that uplink signals that may be received by the second-band access point should be within a designated power range. Accordingly, the control unit 223 may be configured to adjust the uplink amplification factor of the uplink path 204 based on the path loss and the designated power range such that the power of the unintentionally amplified second-band uplink signals may be within or below the designated power range upon reaching the second-band access point. Therefore, the unintentionally amplified second-band uplink signals may not overpower or disrupt other second-band uplink signals that may be received at the second-band access point.

In these or other embodiments, the control unit 223 may also be configured to estimate an increase in the noise floor at the second-band access point that may be caused by the signal booster 202. The control unit 223 may estimate the increase in the noise floor based on noise that may be output by the signal booster 202 and the estimated path loss of and/or distance between the second-band access point and of the signal booster 202.

For example, the signal booster 202 may output noise that may be based on a noise factor of the signal booster 202, the uplink amplification factor, Boltzmann's constant, Temperature, and the frequencies within the second-band. The control unit 223 may estimate the output noise of the signal booster 202 using the above-mentioned factors. The control unit 223 may accordingly estimate the increase in the noise floor at the second-band access point based on its estimated output noise and the estimated path loss between the signal booster 202 and the second-band access point using any suitable procedure.

The control unit 223 may be configured to adjust the amplification factor of the uplink path 204 based on the estimated increase in the noise floor and an allowable noise floor increase associated with the second-band access point such that the increase in the noise floor at the second-band access point may be substantially at or below the allowable noise floor increase. Therefore, the signal booster 202 may be configured such that an increase in the noise floor at the second-band access point that may be caused by the signal booster 202 may be reduced or eliminated.

In some embodiments, the control unit 223 may include a second-band downlink threshold power level of the second-band downlink signal stored therein. The control unit 223 may compare the received second-band downlink signal power with the second-band downlink threshold power level and may adjust the uplink amplification factor when the received second-band signal power exceeds the second-band threshold power level.

The second-band downlink threshold power level may be based on a transmission power of the second-band downlink signal (estimated or known), pathloss and distance, and noise floor and/or overload thresholds associated with the second-band access point that may have been calculated previously. Accordingly, in some embodiments, the control unit 223 may merely compare the received second-band downlink signal power with the second-band downlink threshold power to determine whether or not to adjust the uplink amplification factor instead of performing the above-mentioned calculations.

Modifications, additions, or omissions may be made to FIG. 2 without departing from the scope of the present disclosure. For example, the signal booster 202 may include other components than those explicitly depicted. Additionally, the signal booster 202 may include other amplification circuits (e.g., that may each include uplink and downlink paths) configured for frequency bands other than the first frequency band. Moreover, the number of and type of components included in the signal booster 202 may vary depending on specific implementations. For example, in some embodiments, the signal booster 202 may include one or more signal attenuators and/or one or more signal power detectors configured to detect power of the first-band uplink and/or first-band downlink signals. Additionally, as mentioned above, in some embodiments, the directional coupler 216 may be omitted or replaced with a pick-up resistor or capacitor.

Further, the specific examples of bands given with respect to FIG. 2 are merely to facilitate understanding of the present disclosure and are not limiting. For example, principles similar to those described with respect to FIG. 2 may be used for signal boosters where the first downlink band may be separated from the second uplink and/or second downlink band by a substantially narrow guard band and where operations may be performed to adjust the downlink amplification factor applied by the downlink path 206 based on the detected second-band signals. Additionally, in some embodiments, operations may be performed to detect second-band uplink signals and to adjust the uplink and/or downlink amplification factors based on the second-band uplink signals. Further, in some embodiments, the amplification factors may be adjusted to reduce the interference experienced at a second-band wireless device using some of the same principles described herein. Further, the embodiments described herein are not limited to applications with respect to the 700 MHz Band 13 and public safety band. As such, the scope of the present disclosure is not limited to the embodiments explicitly described herein.

FIG. 3 illustrates an example embodiment of a signal booster 302 configured to provide out-of-band overload and/or noise protection, arranged in accordance with at least some embodiments described herein. In some embodiments, the signal booster 302 may be configured to operate in a manner analogous to the signal booster 102 of the system 100 of FIG. 1. The signal booster 302 may include a first interface port 309, a second interface port 311, a duplexer 312a, a duplexer 312b, and a downlink path 306 with a downlink gain unit 315 that may be configured in an analogous manner to the first interface port 209, the second interface port 211, the duplexers 212a and 212b, and the downlink path 206, respectively, of the signal booster 202 of FIG. 2.

The signal booster 302 may also include an uplink path 304 that may include an uplink gain unit 314. The uplink path 304 may also be configured in a manner analogous to the uplink path 204 of the signal booster 202 of FIG. 2. However, as explained further below, in the illustrated embodiment of FIG. 3, the uplink path 304 may not include a directional coupler (such as the directional coupler 216 of the uplink path 204) configured to direct signals toward a detecting circuit 330 of the signal booster 302.

Similar to the signal booster 202 of FIG. 2, the signal booster 302 may be configured for instances when the uplink path 304 of the signal booster 302 may amplify second-band uplink signals of the out-of-band second frequency band—which, if left unchecked, may disrupt second-band communication, as detailed above. As such, the signal booster 302 may include a detecting circuit 330 configured to detect second-band downlink signals in a manner analogous to the detecting circuit 230 of FIG. 2. For example, in some embodiments, the detecting circuit 330 may include a second-band downlink BPF 334, a gain unit 336 and a detecting unit 338 that may be analogous to the second-band downlink BPF 234, the gain unit 236, and the detecting unit 238 of the detecting circuit 230 of FIG. 2.

However, the signal booster 302 may be configured such that the detecting circuit 330 may be configured to receive the second-band downlink signals that may be received at the second interface port 311 before the second-band downlink signals reach the duplexer 312b. In contrast, as described above, the detecting circuit 230 of FIG. 2 may receive the second-band downlink signals after the second-band downlink signals have passed through the first-band uplink filter of the duplexer 212b.

In the illustrated embodiment, the signal booster 302 may include a directional coupler 316 communicatively coupled between the second interface port 311 and the duplexer 312b. Additionally, the directional coupler 316 may be communicatively coupled to the detecting circuit 330. The directional coupler 316 may be any suitable system, apparatus, or, device configured to direct signals propagating from the second interface port 311 toward the detecting circuit 330 and away from the duplexer 312b. Additionally, the directional coupler 316 may be configured to direct signals propagating from the duplexer 312b toward the second interface port 311 and away from the detecting circuit 330. Therefore, the directional coupler 316 may be configured to direct signals (e.g., second-band downlink signals) that may be received by the second interface port 311 toward the detecting circuit 330. The directional coupler 316 may also accordingly be configured such that signals (e.g., first-band uplink signals) that may leave the duplexer 312b toward the directional coupler 316 may be substantially directed toward the second interface port 311 and away from the detecting circuit 330.

The second-band downlink BPF 334 may be configured to filter out signals that may be received from the directional coupler 316 that may not be within the frequency range of the second-band downlink band in an analogous manner as the second-band downlink BPF 234 of FIG. 2. Therefore, the gain unit 336 and/or the detecting unit 338 may receive and perform operations with respect to the second-band downlink signals similar to the gain unit 236 and the detecting unit 238, respectively, described above with respect to FIG. 2.

Additionally, the control unit 323 may be communicatively coupled to the detecting unit 338 and may be configured to adjust the uplink amplification factor of the uplink path 304 based on the second-band downlink signals that may be detected by the detecting unit 338. In some embodiments, the control unit 323 may adjust the uplink amplification factor in a manner analogous to that described above with respect to the control unit 223 of FIG. 2.

In some instances, the second-band uplink and downlink signals may have frequencies such that the first-band uplink filters of the duplexers 312a and 312b may filter out the second-band downlink signals, but not the second-band uplink signals. Therefore, the detecting circuit 330 may be configured to receive the second-band downlink signals before the second-band downlink signals reach the duplexer 312b such that the duplexer 312b may not filter out the second-band downlink signals before the second-band downlink signals are detected by the detecting circuit 330.

Therefore, the signal booster 302 may also be configured to adjust, based on a second-band signal (e.g., the second-band downlink signal), an amplification factor applied by a circuit (e.g., the uplink path 304) configured and designed for first-band signals. Adjusting the amplification factor based on the out-of-band second-band signals may reduce interference experienced in the second-band that may be caused by the signal booster 302.

Modifications, additions, or omissions may be made to FIG. 3 without departing from the scope of the present disclosure. For example, the signal booster 302 may include other components than those explicitly depicted. Additionally, the signal booster 302 may include other amplification circuits (e.g., that may each include uplink and downlink paths) configured for frequency bands other than the first frequency band. Moreover, the number of and type of components included in the signal booster 302 may vary depending on specific implementations. For example, in some embodiments, the signal booster 302 may include one or more signal attenuators and/or one or more signal power detectors configured to detect power of the first-band uplink and/or first-band downlink signals.

Further, the specific examples of bands given with respect to FIG. 3 are merely to facilitate understanding of the present disclosure and are not limiting. For example, principles similar as those described with respect to FIG. 3 may be used for signal boosters where the first downlink band may be separated from the second uplink and/or second downlink band by a substantially narrow guard band and where operations may be performed to adjust the amplification factor applied by the downlink path 306. Additionally, in some embodiments, operations may be performed to detect second-band uplink signals and to adjust the uplink and/or downlink amplification factors based on the second-band uplink signals. Further, in some embodiments, the amplification factors may be adjusted to reduce the interference experienced at a second-band wireless device using some of the same principles described herein. As such, the scope of the present disclosure is not limited to the embodiments explicitly described herein.

FIG. 4 is a flow chart of an example method 400 of providing overload and/or noise protection, arranged in accordance with at least some embodiments described herein. One or more elements of the method 400 may be implemented, in some embodiments, by a signal booster, such as the signal boosters 102, 202, or 302 FIGS. 1-3, respectively. Although illustrated as discrete blocks, various blocks may be divided into additional blocks, combined into fewer blocks, or eliminated, depending on the desired implementation.

The method 400 may begin at block 402, where an amplification factor may be applied to a first-band signal by an amplification circuit of a transmitting device. In some embodiments, the transmitting device may be a signal booster. The first-band signal may be transmitted in a first frequency band that may include a first uplink band and a first downlink band. Additionally, the amplification circuit may be configured and designed for signals transmitted in the first frequency band such that the first frequency band may be an “in-band” frequency band with respect to the amplification circuit. In some embodiments, the first-band signal may be a first-band uplink signal, while in other embodiments the first-band signal may be a first-band downlink signal. In some embodiments, the first frequency band may be the Band 13 of the 700 MHz band plan and the second frequency band may be the public safety band of the 700 MHz band plan.

At block 404, a second-band signal transmitted in a second frequency band may be detected. The second frequency band may include a second uplink band and a second downlink band. In some embodiments, the second-band signal may be a second-band downlink signal. In other embodiments, the second-band signal may be a second-band uplink signal. Additionally, the amplification circuit may not be configured or designed specifically for signals transmitted in the second frequency band (e.g., second-band uplink or downlink signals) such that the second frequency band may be an out-of-band frequency band.

At block 406, the amplification factor of the amplification circuit may be adjusted based on the detected second-band signal. In some embodiments, the amplification factor may be adjusted based on an estimated path loss and/or distance between the transmitting device and a second-band access point. In these and other embodiments, interference within the second frequency band may be predicted based on the detected second-band signal and the amplification factor may be adjusted based on the predicted interference. In some embodiments, the predicted interference may include an increase in a noise floor associated with the second-band access point. In these or other embodiments, the predicted interference may relate to an estimated received signal strength of the amplified second-band signal as received by the second-band access point. The estimated received signal strength may indicate or predict whether the amplified second-band signal may interfere with or overload other second-band signals that may be received by the second-band access point.

Accordingly, the method 400 may be used to adjust an amplification factor of an amplification circuit configured for first-band signals based on detected out-of-band second-band signals. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the invention.

What is claimed is:

1. A method for providing overload or noise protection, the method comprising:
applying, by an amplification circuit of a transmitting device, an amplification factor to a first-band signal transmitted in a first frequency band that includes a first uplink band and a first downlink band, the amplification circuit being configured for signals transmitted in the first frequency band;
detecting a second-band signal transmitted in a second frequency band that includes a second uplink band and a second downlink band; and
adjusting the amplification factor based on the detected second-band signal.

2. The method of claim 1, further comprising:
predicting interference within the second frequency band based on the detected second-band signal; and
adjusting the amplification factor based on the predicted interference.

3. The method of claim 2, wherein predicting the interference includes determining a predicted increase in a noise floor associated with a wireless communication system access point communicating in the second frequency band.

4. The method of claim 2, wherein predicting the interference includes estimating a received signal strength of an amplified second-band signal received by a wireless communication system access point communicating in the second frequency band, the amplified second-band signal being amplified by the amplification circuit.

5. The method of claim 1, further comprising:
determining an estimated path loss between the transmitting device and a wireless communication system access point, the wireless communication system access point configured to communicate in the second frequency band; and
adjusting the amplification factor based on the estimated path loss.

6. The method of claim 1, further comprising:
determining an estimated distance between the transmitting device and a wireless communication system access point, the wireless communication system access point configured to communicate in the second frequency band; and
adjusting the amplification factor based on the estimated distance.

7. The method of claim 1, wherein the transmitting device is a signal booster.

8. The method of claim 1, wherein the first-band signal is a first-band uplink signal transmitted in the first uplink band of the first frequency band.

9. The method of claim 1, wherein the second-band signal is a second-band downlink signal transmitted in the second downlink band of the second frequency band.

10. The method of claim 1, wherein:
the first frequency band is Band 13 of a 700 megahertz (MHz) band plan; and
the second frequency band is a public safety band of the 700 MHz band plan.

11. A system for providing overload or noise protection, the system comprising:
an amplification circuit configured to apply an amplification factor to a first-band signal transmitted in a first frequency band that includes a first uplink band and a first downlink band, the amplification circuit being configured for signals transmitted in the first frequency band;
a detecting circuit configured to detect a second-band signal transmitted in a second frequency band that includes a second uplink band and a second downlink band; and
a control unit configured to adjust the amplification factor based on the detected second-band signal.

12. The system of claim 11, wherein the control unit is further configured to:
predict interference within the second frequency band based on the detected second-band signal; and
adjust the amplification factor based on the predicted interference.

13. The system of claim 12, wherein the control unit is further configured to determine a predicted increase in a noise floor associated with a wireless communication system access point communicating in the second frequency band to predict the interference within the second frequency band.

14. The system of claim 12, wherein the control unit is further configured to estimate a received signal strength of an amplified second-band signal received by a wireless communication system access point communicating in the second frequency band to predict the interference within the second frequency band, the amplified second-band signal being amplified by the amplification circuit.

15. The system of claim 11, wherein the control unit is further configured to:
determine an estimated path loss between the transmitting device and a wireless communication system access point, the wireless communication system access point configured to communicate in the second frequency band; and
adjust the amplification factor based on the estimated path loss.

16. The system of claim 11, wherein the control unit is further configured to:
determine an estimated distance between the transmitting device and a wireless communication system access point, the wireless communication system access point configured to communicate in the second frequency band; and
adjust the amplification factor based on the estimated distance.

17. The system of claim 11, wherein the first-band signal is a first-band uplink signal transmitted in the first uplink band of the first frequency band.

18. The system of claim 11, wherein the second-band signal is a second-band downlink signal transmitted in the second downlink band of the second frequency band.

19. The system of claim 11, wherein:
the first frequency band is Band 13 of a 700 megahertz (MHz) band plan; and
the second frequency band is a public safety band of the 700 MHz band plan.
